(19) United States
(12) Patent Application Publication
(10) Pub. No.: US 2010/0078243 A1
(43) Pub. Date: Apr. 1, 2010

(54) Automobile waste oil recycler

(76) Inventor: Craig S. Tokarik, Cream Ridge, NJ (US)

Correspondence Address: Mandel & Peslak, LLC, Suite 5, 80 Scenic Drive, Freehold, NJ, 07728, US

(21) Appl. No.: 12/286,422

(22) Filed: Sep. 30, 2008

(51) Int. Cl. F16N 31/02; B65D 1/34

(52) U.S. Cl. 180/69.1; 184/106; 220/573

(57) ABSTRACT

What is disclosed is a device for the collection of fluids that may leak from the engine or transmission of an automobile. The device includes a surface upon which the fluids will collect, a reservoir mounted under the surface and a means for attaching the device under the engine compartment of an automobile.

### BACKGROUND OF THE INVENTION

The present invention is directed to the field of automobiles. Due to various factors, automobiles over time begin to leak various fluids such as oil, transmission fluid, brake fluid, anti-freeze, etc. The fluids leak out and begin to drip onto the ground. When this happens, driveways and other parking areas become discolored and ultimately the environment becomes unnecessarily contaminated.

The present invention is directed to a collection device that can be attached to the bottom of an automobile. The device acts to safely collect and temporarily store the fluids for safe removal and disposal. The fluids can be easily removed from the collection device so that the fluids can be properly disposed of or recycled. Thus, the primary object of the present invention is to solve the problem of easily collecting fluids dripping from the bottom of an automobile.

### SUMMARY OF THE INVENTION

The purpose of this device is to collect engine fluids for recycling or safe disposal. Engine fluids leaking from cars and trucks are one of the primary elements of non-point source pollution, which affects our wildlife, waterways, farmlands and even human health. The goal of the automobile fluid recycler is to eliminate these fluids as a source of this pollution.

### BRIEF DESCRIPTION OF THE DRAWINGS

FIG. 1 is a plan view of an embodiment of the present invention.

FIG. 2 is a top view of an embodiment of the present invention.

FIG. 3 is a side view of an embodiment of the present invention.

FIG. 4 is a side view of an embodiment of the present invention.

FIG. 5 is a cross-sectional view of an embodiment of the present invention.

FIG. 6 is a top view of an embodiment of the present invention.

FIG. 7 is a bottom view of an embodiment of the present invention.

FIG. 8 is a side view of the present invention shown installed on an automobile.

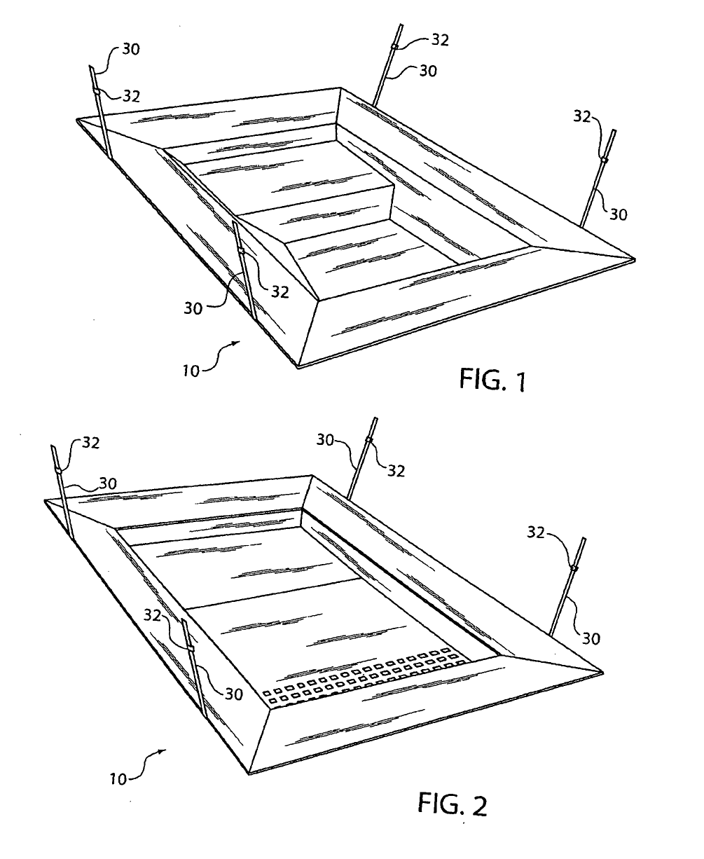

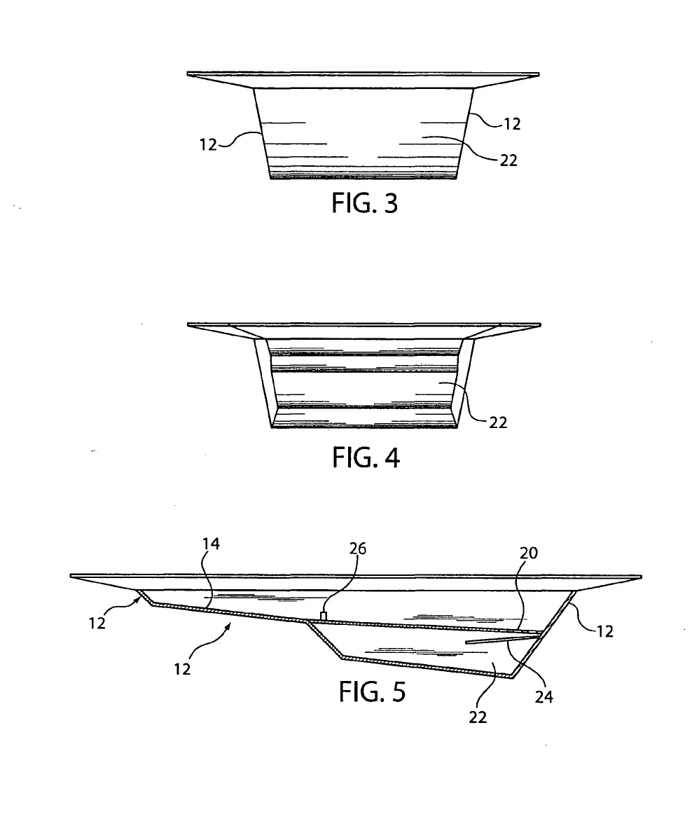

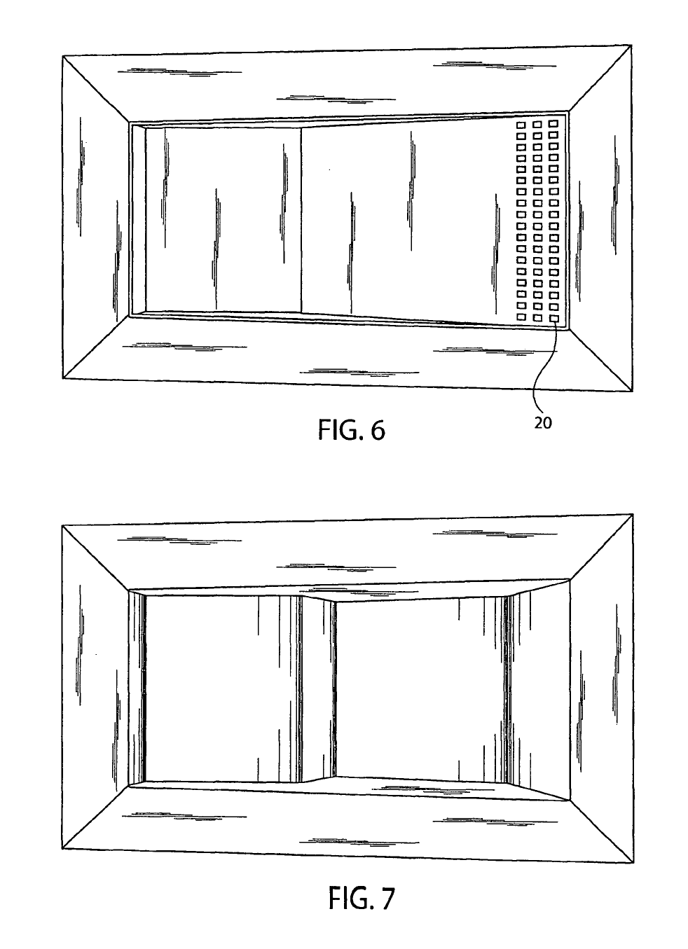

### DETAILED DESCRIPTION OF THE INVENTION

The present invention will now be described in terms of the presently preferred embodiment thereof as illustrated in the drawings. However, those of ordinary skill in the art will recognize that many obvious modifications may be made thereto without departing from the spirit or scope of the present invention.

The automobile fluid recycler 10 of the present invention is illustrated in the drawings. The recycler 10 is shown in profile in FIG. 5. As can be seen therein, the recycler 10 forms a reservoir 22 that collects oil. The side walls 12 are sloped downward to a first bottom surface 14. When installed, the first bottom surface 14 will slope downward toward a screen 20. Any fluids that fall from the engine or transmission will initially accumulate upon the first bottom surface 14 and then be drawn by gravity toward the openings in a screen 20. The fluids will then fall through the screen 20 and into a reservoir 22.

The reservoir 22 comprises a gate 24. The gate 24 directs the fluids from the openings in the screen 20 into the reservoir 22. In addition, the gate 24 prevents the fluid from backing up and out of the reservoir 22. The reservoir 22 further comprises a removable drain cap 26. The drain cap 26 is situated at the highest point of the reservoir 22 to allow for easy removal of the fluids therefrom. It is contemplated that the recycler 10 will be removed from the car to drain the fluids collected in the reservoir 22. After the fluids are removed, the reservoir 10 will be reinstalled under the car as described herein.

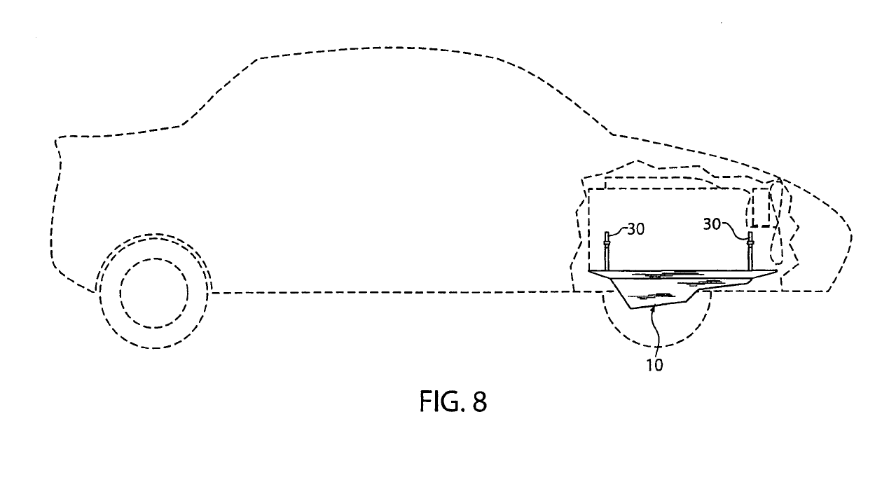

The recycler 10 is installed under the engine compartment of the automobile so as to be able to collect any fluids that may leak from the engine or the coupling between the engine and the transmission. One method of installation is illustrated in FIG. 8. The recycler 10 further comprises metal straps 30. The metal straps 30 attach to tension clips 32 by means of rivets, screws or similar fasteners. The tension clips 32 are then attached to existing support structures on the bottom of the automobile. Although the recycler 10 is secured by means of the tension clips 32, it is easy to remove the device after installation for service and normal maintenance.

Those of ordinary skill in the art will recognize that the foregoing merely describes one embodiment of the present invention and that many obvious modifications may be made thereto without departing from the spirit or scope of the present invention as set forth in the appended claims.

What is claimed is:

1. A device for collecting automobile fluids from an automobile comprising:
a. A first collection surface that is sloped from a top edge to a bottom edge whereby the fluids leaking from an engine or transmission will fall thereupon;
b. A plurality of openings in the first collection surface near the bottom edge through which the fluids can pass;
c. A gate mounted under the plurality of openings to direct the fluids downward;
d. A reservoir under the gate comprising side surfaces and a bottom surface and a top surface wherein the top surface comprises the first collection surface for the collection of the fluids wherein the reservoir comprises an opening in the top surface to facilitate removal of the automobile fluids from the reservoir; and
e. A means for removeably attaching the device to existing support structures on the bottom of an automobile.

2. The device of claim 1 wherein the means for attaching the device are a plurality of straps and tension clips.
